(19) United States
(12) Patent Application Publication
(10) Pub. No.: US 2001/0036073 A1
(43) Pub. Date: Nov. 1, 2001

(54) Carvable decorative gourd

(76) Inventor: Christine K. Trease, Price, UT (US)

Correspondence Address: MARCUS G THEODORE, PC, 466 SOUTH 500 EAST, SALT LAKE CITY, UT, 84102, US

(21) Appl. No.: 09/838,616

(22) Filed: Apr. 19, 2001

Related U.S. Application Data
(60) Provisional application No. 60/198,429, filed on Apr. 19, 2000.

(51) Int. Cl. F21V 33/00

(52) U.S. Cl. 362/154; 362/122; 362/124; 362/808

(57) ABSTRACT

An artificial hollow carvable gourd shaped as a pumpkin, squash, or other fruit or vegetable, having an outer carvable shell, which encases fake “innards and seeds” made of edible candy, and including a prize, contained therein to provide a more realistic gourd container.

### RELATED APPLICATIONS

This application is a continuation-in-part application of the provisional application entitled “Carvable Decorative Gourd”, Serial No. 60/1908,429, filed Apr. 19, 2000,

### BACKGROUND OF THE INVENTION

1. Field.

This invention relates to novelty packaging. More particularly, it relates to a package for candy and toys, which can be carved into a decorative novelty.

2. State of the Art.

Carvable gourds have been used for years to celebrate holidays, such as Halloween. These gourds are messy to clean and require disposal of the innards. To avoid this problem, a number of hollow carvable artificial pumpkin shells are known. Chapman, U.S. Pat. No. 5,397,609 discloses a carvable three-dimensional artificial pumpkin made of a polyurethane shell covered with a thin elastomeric coating, and method for making the same. Chapman, U.S. Pat. No. 5,624,614 discloses a method of forming carvable hollow shell articles. Chapman, U.S. Pat. No. 5,491,007 discloses a carvable artificial pumpkin and method. Chapman, U.S. Pat. No. 5,811,160 discloses another carvable hollow artificial pumpkin. These Chapman patents covering a hollow carvable shell do not contain innards, which have to be removed for carving. They therefore do not have the weight or feel of a live pumpkin or gourd.

Caflish, et al., U.S. Pat. No. 5,162,138 discloses pumpkin decorations comprising decorative pieces of vinyl which stick to a pumpkin or gourd via an adhesive. Static cling pieces are then affixed to the vinyl pieces to form faces or decorative patterns without having to carve the pumpkin or gourd.

Cited for general interest is Bryan, U.S. Pat. No. 5,876,995, which discloses bioluminescent novelty items, which can have a Halloween theme.

None of these references provides a decorative container having candy and toy innards, having the weight and feel of a natural pumpkin or guard, which can be carved and decorated after the container is opened. The invention described below provides such an invention.

### SUMMARY OF THE INVENTION

The invention comprises a novelty container with innards comprising: a carvable gourd shaped container defining at least one opening leading into a hollow interior. The container is made of a material, which is not only carvable, but retains its shape when filled. Artificial innards are then placed within the hollow interior to add weight to the container to give it a more realistic weight and feel to a natural gourd or pumpkin. An openable seal then is placed over the opening to secure the innards within the hollow interior. If the innards are edible, the assembled novelty container provides a novel candy packaging and dispenser system, which is colored or patterned to suit the season. For example, orange jack-o-lantern pumpkins are used for Halloween. Green gourds are used for St. Patrick's Day, etc.

The container may be carved with a face to provide a personalized candy dispenser or ornament. A prize may be included with the innards to provide an added surprise. To aid in removing the innards, a shovel scoop may be included.

For a more realistic look, the carvable gourd may include a stem attached to a top base segment of the container. The base is scored to aid in its removal by the stem, thus providing a handle cover to lift the filled gourd when the seal is intact, or to access the candy innards if the seal has been broken.

After the candy innards are removed or eaten, the seal of a bottom opening may be removed to provide an opening for the insertion of an optional lighting system. This lighting system may be included in a kit and is structured to fit within the opening to light the interior and shine through openings carved in the container.

In one preferred embodiment the carvable gourd is shaped as a pumpkin. The innards are made of candy and shaped like pumpkin seeds and strings. These may be colored to resemble an actual pumpkin interior. Included within the pumpkin container is a small shovel to aid in removing the pumpkin candy innards.

In another preferred embodiment, the novelty container may be constructed of breakable plastic, which when struck, breaks and releases the artificial innards so that the container can be used as a pinnate.

The breakable and unbreakable containers are colored or patterned to suit the preference of a user to match the theme of a holiday or event. This container may be customized via carving and saved from year to year as a momento of the event, or simply re-used.

It is also envisioned to include bodies structured for attachment to the container gourd heads. These bodies are doll forms of varying themes, patterns, and decorations to match the theme of a holiday, or event. For example, a snowman body may be structured to attach to a white gourd head for a winter theme.

In other variations, body parts may be included such that the gourd forms the body, and the body parts are then added. For example, a turkey may be made from an orange pumpkin shaped gourd, which forms the body of a turkey. Feather parts, a beard and feet are then added to form the turkey. This variation is particularly useful where breakable containers are decorated and hung as a pinnate. The stem of these breakable gourd containers is adapted to attach to a swinging line, so it can be moved as part of the contest.

Preferably the carvable gourd is sold as a kit including, a carvable container with candy innards, a carving knife, seed shovel, and a lighting kit sealed therein. The carvable container is then unsealed and the container is carved for use as a candy dispenser, or upon removal of the innards, as a jack-o-lantern. In another variation, the kit may also include a thematic doll body form to attach to the carved container to form a doll. It may also include a tube of glue to re-glue the removed carved pieces to restore the gourd for future carving.

Preferably the container is made of a water resistant material, which can be used out of doors.

### DESCRIPTION OF THE DRAWINGS

FIG. 1 is a perspective view of a preferred embodiment of the invention.

FIG. 2 is a view of the lighting system used with the preferred embodiment shown in FIG. 1.

FIG. 3 is a perspective view of a preferred embodiment including a doll body.

FIG. 4 is a perspective view of another preferred embodiment.

FIG. 5 is a perspective view of the interior.

### DESCRIPTION OF THE ILLUSTRATED EMBODIMENTS

The invention comprises a hollow carvable gourd container 10, shaped as a pumpkin, squash, or other fruit or vegetable, having an outer carvable shell and a stem 11, which encases fake “innards and seeds” 12 contained therein. The fake “innards and seeds” may be made of edible candy, or include a prize and add weight to give the semblance of a real gourd. To remove the fake “innards and seeds”, the top 13 is generally perforated for easy cutting. The stem 11 has a hole 14 for attachment to a line for use as a pinnate.

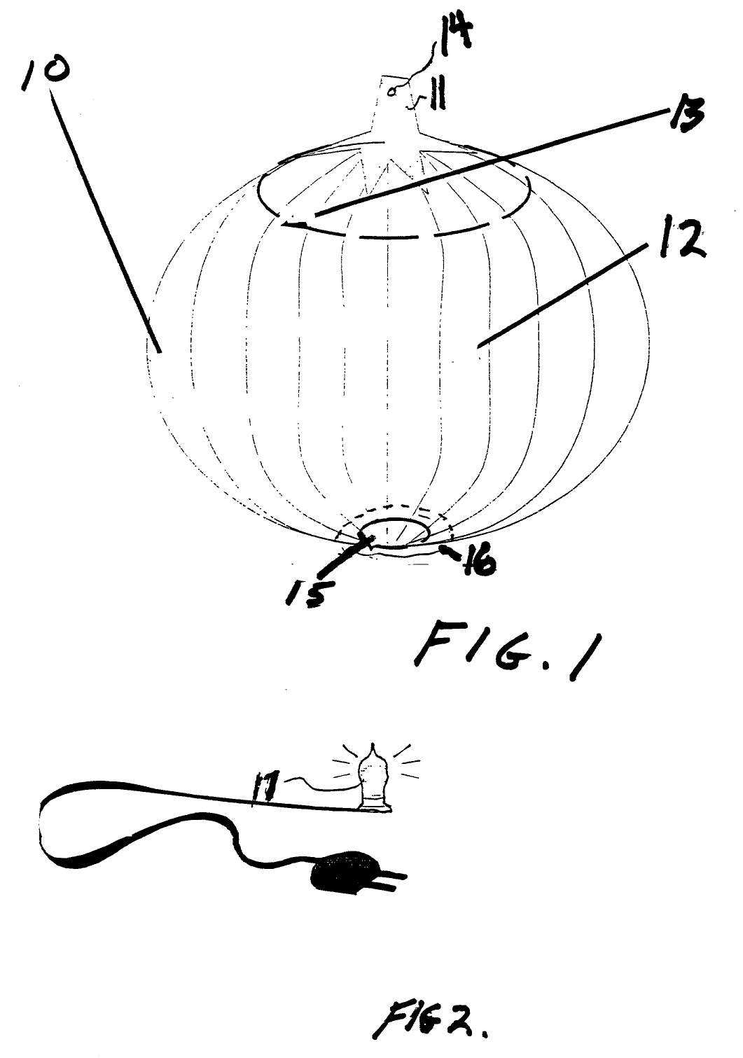

The preferred skin covering is made of latex covering polyurethane foam, which is colored or patterned to suit the preference of a user as shown in FIG. 1. It is then carved into a desired shape with eyes, nose, a mouth, etc. The bottom of the gourd 10 has a sealed bottom 15, covered with a removable cover 16, which is removed to allow insertion of a light kit 17 shown in FIG. 2.

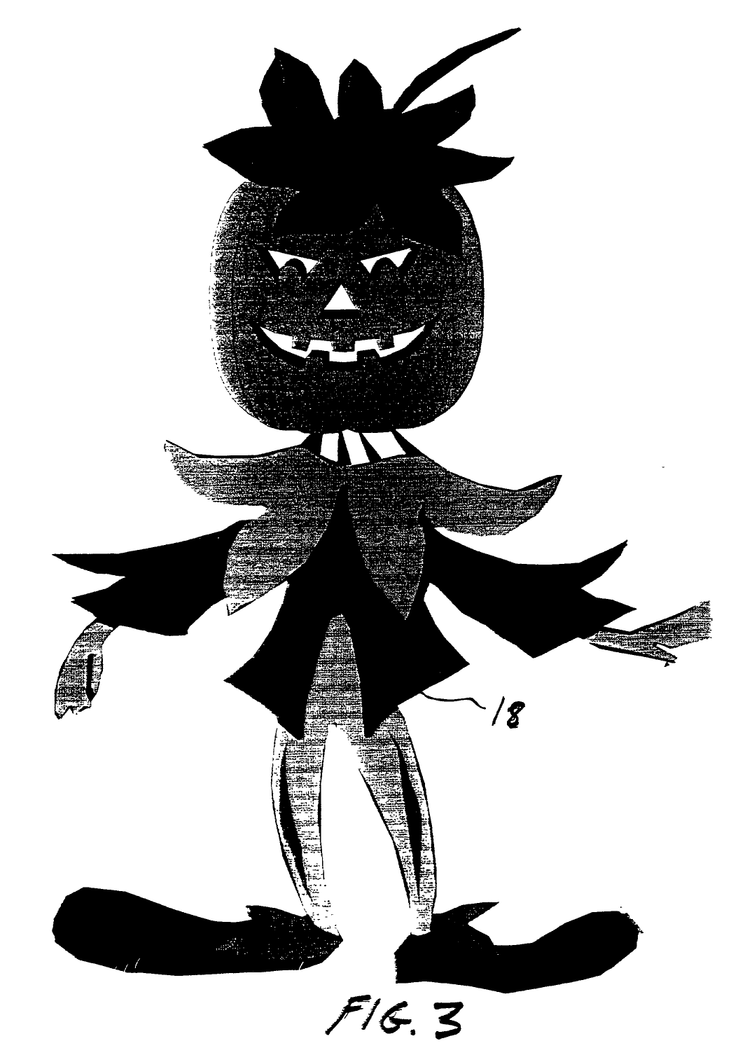

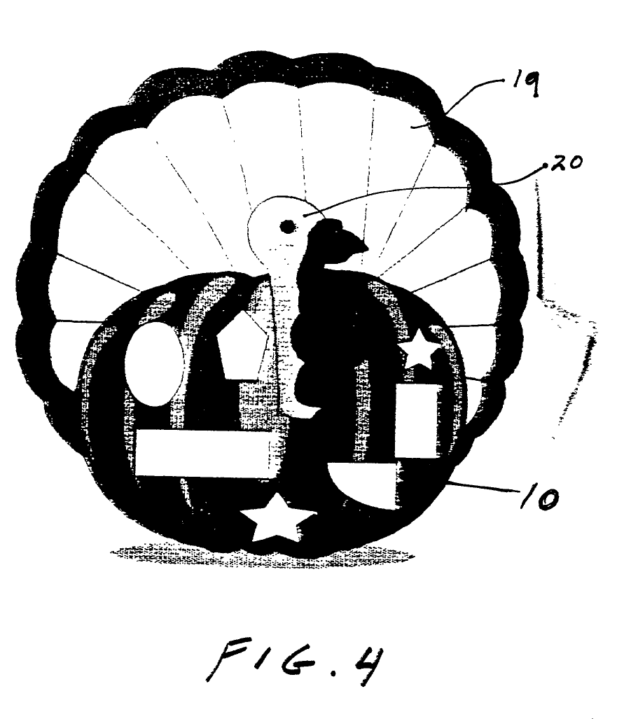

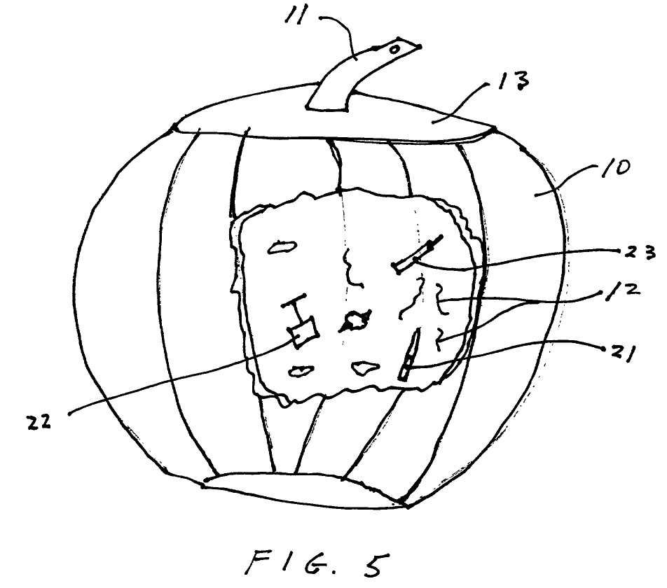

Preferably, the gourd 10 is shaped to provide a decorative ornament, when carved, which has a seasonal or holiday theme. A doll body 18 may be attached as shown in the jack-o-lantern scarecrow in FIG. 3. Additional body parts, such as a tail 19, and head 20 may be attached to the gourd to form a turkey shown in FIG. 4.

The carved gourd 10 may be included in a carving kit comprised of carving knives 21, and a seed shovel 22 shown in FIG. 5. The carving kit may include a sealant 23 to re-seal the cut-out parts of the container 10 for re-use and re-carving at a later date.

Once carved, the jack-o-lantern provides a childhood momento, which can be save and re-used. As it is made of a water resistant material, it may be used as a lawn ornament or in the outdoors. The carved gourd 10 may then placed on a body 18, such the scarecrow shown in FIG. 3.

The carvable gourd container 10 thus provides an ideal candy container convertible into a toy or novelty item suitable for decorative holiday use or play.

Although this specification has made reference to the illustrated embodiments, it is not intended to restrict the scope of the claims. The claims themselves recite those features deemed essential to the invention.

I claim:

1. A novelty container with innards comprising:
a. a carvable gourd shaped container made of a material to retain its shape when filled, and defining at least one opening leading into a hollow interior,
b. artificial innards placed within the hollow interior through the opening to add weight to the container,
c. an openable seal attached to the container covering the opening to secure the innards within the hollow interior.

2. A novelty container according to claim 1, wherein the innards are edible.

3. A novelty container according to claim 2, wherein the innards are candy, and include toys.

4. A novelty container according to claim 1, including a shovel scoop to aid in removing the innards.

5. A novelty container according to claim 1, wherein the carvable gourd has stem attached to a base segment of the container, which is scored to aid in its removal.

6. A novelty container according to claim 5, including a lighting system structured to fit within the opening when the innards are removed to light the interior and shine through openings carved in the container.

7. A novelty container according to claim 6, wherein the carvable gourd is shaped as a pumpkin.

8. A novelty container according to claim 1, wherein the container is constructed of breakable plastic, which, when struck, releases the artificial innards.

9. A novelty container according to claim 1, wherein the container is colored or patterned to suit the preference of a user.

10. A novelty container according to claim 1, wherein the innards are candy and shaped like pumpkin seeds and strings.

11. A novelty container according to claim 1, wherein the container is made of a water resistant material.

12. A novelty container kit comprising:
a. a carvable gourd shaped container having a stem made of a material to retain its shape when filled, and defining at least one opening leading into a hollow interior, the stem attached to a top base segment of the container which is scored to aid in removal of the stem and top base segment,
b. edible innards shaped like seeds and strings, placed within the hollow interior through the opening to add weight to the container,
c. an openable seal attached to the container covering the opening to secure the innards within the hollow interior,
d. a seed scoop,
e. a carving knife, and
f. a lighting system structured to fit within the opening when the innards are removed to light the interior and shine through openings carved in the container.

13. A novelty container kit according to claim 12, including a source of glue to re-glue removed pieces of gourd to restore the gourd for re-carving into a different shape.
